(19) United States
(12) Patent Application Publication
(10) Pub. No.: US 2026/0314538 A1
(43) Pub. Date: Oct. 15, 2026

(54) HAND-HELD GARDEN TOOL FOR OPERATOR-CONTROLLED POSITIONING OF A KNIFE CARRIER

(71) Applicant: Andreas Stihl AG & Co. KG, Waiblingen (DE)

(72) Inventors: Samuel Müller, Herrenberg (DE); Manuel Waiblinger, Stuttgart (DE)

(73) Assignee: Andreas Stihl AG & Co. KG, Waiblingen (DE)

(21) Appl. No.: 19/392,804

(22) Filed: Nov. 18, 2025

(30) Foreign Application Priority Data
Nov. 21, 2024 (DE) 102024134325.7

(51) Int. Cl. A01G 3/053; A01G 3/04

(52) U.S. Cl. CPC A01G 3/053; A01G 2003/0461

(57) ABSTRACT

A garden tool for operator-controlled positioning of a knife carrier, comprising at least one reciprocatingly driven knife carrier, a handle with a throttle lever, a drive motor for driving the knife carrier and a control apparatus for controlling a speed of the drive motor, wherein the control apparatus is designed to control the speed of the drive motor as a function of a selectable positioning mode of the garden tool, and wherein the speed of the drive motor in the positioning mode is limited to a positioning speed, such that the knife carrier is moved back and forth at most twice per second, in particular at most once per second, in the positioning mode, so that the position of the knife carrier can be selected by the operator by releasing the throttle lever or an operating element of the garden tool other than the throttle lever.

### CROSS-REFERENCE TO RELATED APPLICATIONS

This application claims priority of German Patent Application No. 10 2024 134 325.7, filed Nov. 21, 2024. The disclosure of this prior application is considered part of the disclosure of this application and is hereby incorporated by reference in its entirety.

### FIELD

The disclosure relates to a hand-held garden tool designed to position at least one knife carrier in an operator-controlled manner.

### BACKGROUND

Hand-held garden tools such as hedge trimmers or rotary trimmers have a cutting apparatus for trimming hedges, shrubs, grass, and the like. Typically, such a cutting apparatus has several knives on two knife carriers arranged one above the other, at least one of the knife carriers being movable. If the two knife carriers together with their knives are moved relative to each other, two knives from different knife carriers work together in pairs and in part, thus functionally realizing a plurality of shears.

However, it has been found to be disadvantageous in well known cutting apparatuses that the knives can wear to different degrees along the knife carriers. This can be caused, for example, by an operator using only part of the total length or circumference of the knife carrier. For regrinding the knives, it is therefore not sufficient to align the upper knife carrier with the lower knife carrier once, as this alignment is not suitable for all areas of the knife carrier due to the different wear of the knives along the knife carriers. Instead, it is necessary for the operator to align the knife carriers with each other using visual inspection so that a first part of the knives can be resharpened first and the operator then aligns the knife carriers with each other so that a second part of the knives can be resharpened. To date, it has not been possible to easily or reproducibly align the knife carriers with each other in the alignment desired by the operator. The position in which the knife carriers of the garden tool come to a stop after the throttle lever or an operating element other than the throttle lever is released cannot be predicted by the operator. Many attempts are therefore necessary to randomly obtain a position of the knife carriers that is as close as possible to the desired alignment. As a result, re-sharpening is time-consuming and the operator can use a position of the knife carriers for re-sharpening that does not correspond to the alignment desired by him.

The object is therefore to specify a hand-held garden tool that is improved regarding the aforementioned disadvantages for the operator-controlled positioning of a knife carrier. This object is solved by the means of the present disclosure.

### SUMMARY

According to the disclosure, the hand-held garden tool comprises a control apparatus which is designed to control the speed of the drive motor as a function of a selectable positioning mode of the garden tool, wherein the speed of the drive motor in the positioning mode is limited to a positioning speed such that the knife carrier in the positioning mode is moved back and forth at most twice per second, in particular at most once per second.

Operator-controlled positioning of a knife carrier means that when the throttle lever or an operating element of the garden tool other than the throttle lever is released, the drive motor is either stopped by the control apparatus or, if the drive motor is already at a standstill, the motor is maintained at a standstill, thus preventing the knife carrier from being driven. The knife carrier thus essentially maintains the position it had when the drive motor stopped. Therefore, the operator selects the position of the knife carrier by the time at which he releases the throttle lever or the operating element other than the throttle lever. If the garden tool has a two-hand control, the operating element other than the throttle lever can in particular be another operating element of the two-hand control.

The hand-held garden tool has a working mode in which the garden tool is operated by the user to cut hedges, shrubs, grass, and the like. In the working mode and at full throttle, i.e. when the throttle lever is fully operated or at degree of actuation of the throttle lever of 100%, the knife carrier usually moves back and forth at least 40 times per second. Such a high cutting frequency results in a smooth cut. A high cutting frequency is particularly necessary for trimming, i.e. cutting thin branches, in order to achieve a good sectional image.

Due to the fact that the maximum speed of the drive motor in the positioning mode is greatly reduced compared to the maximum speed of the drive motor in the working mode, namely so that the knife carrier is only moved back and forth at most twice, in particular at most once instead of at least 40 times per second, the maximum speed of the knife carrier is also greatly reduced, so that the knife carrier can be stopped much more precisely in a position desired by the operator. This is related to the fact that the movement of the at least one driven knife carrier in the positioning mode is much slower than in the working mode, so that the operator can more easily visually detect the relative position of both knife carriers and can therefore also select the point of stop more accurately. Due to the fact that the speed in the positioning mode is greatly reduced compared to the speed in the working mode, the kinetic energy stored in the drive train is also lower, so that the at least one driven knife carrier also comes to a standstill more quickly, in particular immediately after the throttle lever or the operating element other than the throttle lever is released. Due to the fact that the positioning speed is limited, any possible follow-up movement of the knife bar is reproducible and can therefore be taken into account by the operator. In this way, the operator can adjust the intended alignment of the knife carriers relative to each other in a fewer number of attempts, in particular in a single attempt.

The design of a hand-held garden tool with at least one reciprocating driven knife carrier is known to those skilled in the art. A drive motor drives a conversion gear, which is often designed as an eccentric gear, in order to convert the continuous rotation of the drive motor into a reciprocating translational or reciprocating rotational movement of the knife carrier. The drive motor is designed in particular as an electric motor. The drive motor can be a DC motor or an EC motor. In many cases, a reduction gear is arranged between the drive motor and the conversion gear, which can be designed as a planetary gear, for example, to reduce the rated speed provided by the drive motor. Due to the fact that various transmission ratios are known in the prior art, the absolute value of the positioning speed depends on the gear of the garden tool. The drive motor can be supplied with energy by one or more accumulators. It can also be provided that the drive motor is mains-powered.

By actuating the throttle lever, for example by moving or swiveling the throttle lever, a control apparatus of the garden tool causes the drive motor to operate. It can be provided that the control apparatus only operates the drive motor if one or more other conditions are fulfilled. One condition can be, for example, an activated two-hand control. An activated two-hand control means that, in addition to the throttle lever, the other operating element operated by the second hand is also being operated. The control apparatus is designed in particular to detect actuation of the throttle lever and, if present, of the other operating element. The control apparatus is designed to detect actuation of the throttle lever. The throttle lever can be designed such that it only transmits an actuated signal or an unactuated signal to the control apparatus. This can be done, for example, via a pushbutton switch on the throttle lever or operating handle. The throttle lever can also be designed such that it transmits additional information on the degree of actuation of the throttle lever to the control apparatus in addition to an actuated signal or an unactuated signal. In many cases, the degree of actuation is detected by a potentiometer or a Hall sensor assembly. The degree of actuation indicates the position of the throttle lever within a range of actuation of the throttle lever from an unactuated state to a maximally actuated state. Between the unactuated state of the throttle lever and the maximally actuated state of the throttle lever there is a range of actuation of the throttle lever of 100%. The degree of actuation 0% is assigned to the unactuated state of the throttle, and the degree of actuation 100% is assigned to the maximally actuated state of the throttle. An intermediate position of the throttle is assigned a degree of actuation between 0% and 100%, excluding 0% and 100%, corresponding to the intermediate position. The garden tool can have further operating elements the actuation of which is detected by the control apparatus and taken into account when deciding on the operation of the drive motor and/or the selection of the working mode. The control apparatus can be designed to evaluate further operating parameters of the drive motor. The control apparatus can comprise a control board, in particular be formed by a control board. The control apparatus can be designed to be connected directly or indirectly to at least one accumulator for supplying energy to the drive motor.

In one example, the control apparatus is designed to activate the positioning mode by actuating the throttle lever, in particular when the control apparatus detects that i) the throttle lever is actuated to a degree of actuation which is less than or equal to a limit degree of actuation, or ii) the throttle lever is actuated in an actuation pattern stored in the control apparatus and the throttle lever is actuated within a specified time period after the actuation pattern is performed, or iii) an operating element other than the throttle lever, in particular in an actuation pattern stored in the control apparatus, is actuated and the throttle lever is then actuated within a specified time period. The first option i) is only available if the control apparatus can detect intermediate positions of the throttle lever. This can be achieved, for example, by means of a throttle lever with a potentiometer or a Hall sensor assembly or similar apparatus. The limit degree of actuation is stored in the control apparatus. The limit degree of actuation is selected in particular from a value range of 10% degree of actuation to 50% degree of actuation. A limit degree of actuation of, for example, 10% means that the positioning mode is activated by the control apparatus as long as the degree of actuation of the throttle lever is at most 10%. The second option (ii) can also be used if the control apparatus cannot detect intermediate positions of the throttle lever. For this purpose, the throttle lever is actuated in an actuation pattern, for example in the manner of a double click, and the control apparatus is designed to detect the actuation pattern. If the throttle lever is actuated again within the specified time period, the positioning mode is activated. According to the third option iii), it can also be provided that the control apparatus is informed via an operating element other than the throttle lever that the positioning mode is to be started and that this is carried out as soon as the throttle lever is actuated within the specified time period after the operating element other than the throttle lever is actuated. If a two-hand control is available, the operating element other than the throttle lever can be the other operating element of the two-hand control. The operating element other than the throttle lever can in particular be actuated in an actuation pattern and in this way start the positioning mode when the throttle lever is actuated within the specified time period after the actuation pattern is performed.

In one example, the control apparatus is designed to deactivate the positioning mode when the control apparatus detects that the throttle lever has been released. The garden tool is designed such that neither the positioning mode nor the working mode can be active when the throttle lever is not actuated. This ensures that a movement of the at least one knife carrier is only carried out when the operator indicates this by actuating the throttle lever. This makes the garden tool particularly easy and intuitive to operate. If a two-hand control is available, it can also be provided that the control apparatus initiates a deactivation of the positioning mode as a result of detecting the release of the other operating element of the two-hand control.

By holding the throttle lever permanently in the positioning mode, the garden tool can be easily switched from the positioning mode to the working mode when the operator simply operates the throttle lever more firmly. A firmer operation corresponds to a greater degree of actuation. The positioning mode can therefore switch directly to the working mode. In this context, directly means that the drive motor is neither switched off in the meantime nor does it change its direction of rotation, but simply rotates faster. In one example, the control apparatus is designed to deactivate the positioning mode when the control apparatus detects that the degree of actuation of the throttle lever has exceeded the limit degree of actuation of the throttle lever and/or the degree of actuation of the throttle lever has increased by at least one limit range of actuation of the throttle lever. The limit degree of actuation is stored in the control apparatus. The limit degree of actuation is selected in particular from a value range of 10% degree of actuation to 50% degree of actuation. A limit degree of actuation of, for example, 10% means that the positioning mode is terminated when the degree of actuation of the throttle lever exceeds 10%. The limit range of actuation is stored in the control apparatus. The limit range of actuation is a section of the range of actuation. The limit range of actuation is in particular between 10% and 50% of the range of actuation. A limit range of actuation of, for example, 20% means that the positioning mode is terminated when the degree of actuation of the throttle lever changes from, for example, 5% to 25%, i.e. by at least 20% of the range of actuation of the throttle lever. A hysteresis can be stored for activating or deactivating the positioning mode, after which the positioning mode is activated when the degree of actuation is between 1% and 10%, for example, and the positioning mode is deactivated when the degree of actuation exceeds 20%, for example. Therefore, a slight increase in the degree of actuation of less than 10% does not lead to a switch to the working mode. The hysteresis allows the throttle lever to be moved slightly beyond the 10% degree of actuation after activation of the positioning mode without the working mode starting unintentionally. In particular, the garden tool is designed in such a way that it only switches directly from the positioning mode to the working mode when the degree of actuation is increased by at least the limit range of actuation. When the positioning mode switches to working mode, the positioning mode is terminated, i.e. deactivated.

In the positioning mode, the thermal load on the drive motor is increased due to a reduced cooling capacity. The positioning mode should therefore only be used temporarily and not permanently. Due to the significantly reduced speed of the at least one driven knife carrier, the positioning mode is not intended for cutting plants and the like. The positioning mode serves to bring the at least one knife carrier into a specific relative position to another knife carrier in order to be able to easily maintain, in particular resharpen, the at least one driven knife carrier when mounted on the garden tool. In one example, the control apparatus is designed to deactivate the positioning mode when the control apparatus detects that a positioning time period that has elapsed since activation of the current positioning mode is greater than a maximum positioning time period stored in the control apparatus. The maximum positioning time period is at most one minute, in particular at most 30 seconds, and most particularly at most 15 seconds. It can be provided that the maximum positioning time period is reduced by the control apparatus if the control apparatus determines that, within a defined time range, the sum of all positioning time periods lying within the time range exceeds a limit value and/or a monitored temperature of the drive motor exceeds a temperature limit value. After the garden tool has been operated once in the working mode, in particular for a third holding period, a new time range can begin in which the previous positioning time periods are no longer added together.

It can be provided that the control apparatus monitors only one of the four aforementioned conditions for deactivation of the positioning mode and deactivates the positioning mode as soon as this single condition, in particular the release of the throttle lever, is fulfilled for deactivation of the positioning mode. It can be provided that the control apparatus monitors at least two of the four aforementioned conditions for deactivation of the positioning mode and deactivates the positioning mode as soon as a single one of these conditions is fulfilled for deactivation of the positioning mode. It can be provided that the control apparatus monitors at least two of the four aforementioned conditions for deactivation of the positioning mode and deactivates the positioning mode as soon as at least two of these conditions are fulfilled for deactivation of the positioning mode.

When the garden tool is in the working mode, the maximum permissible speed of the drive motor is usually its rated speed. In many cases, depending on the drive motor used, the rated speed is between 15,000 and 40,000 revolutions per minute. The rated speed can be reduced by a reduction gear, resulting in a reduced speed at the conversion gear. In many cases, depending on the drive motor and reduction gear used, the conversion gear has a reduced speed of between 2,500 and 6,000 revolutions per minute, which corresponds to 40 to 100 revolutions per second. For each revolution of the conversion gear, the knife carrier is moved back and forth once, i.e., a double stroke is performed. The knife carrier therefore performs 40 to 100 double strokes per second in the working mode. Here, the term double stroke designates both a translational back-and-forth movement and a rotary back-and-forth movement. In one example, the control apparatus is designed to control the speed of the drive motor in the positioning mode and when the throttle lever is continuously actuated in such a way that the speed of the drive motor lies within a first speed range, the first speed range extending from zero revolutions per minute to a positioning speed, the positioning speed corresponding to a maximum of 2% of the rated speed of the drive motor.

In the positioning mode, the maximum permissible speed of the drive motor is the positioning speed. The positioning speed can be between 0.5% and 2% of the rated speed of the drive motor used, for example. In the positioning mode, only a maximum of 0.5% to 2% of the number of double strokes in the working mode are performed per time unit. Depending on the speed of the conversion gear, this means a maximum of 0.2 to 0.8 double strokes per second at a conversion gear speed of 2,500 revolutions per minute and a maximum of 0.5 to 2 double strokes per second at a conversion gear speed of 6,000 revolutions per minute.

In one example, the control apparatus is designed to keep the speed of the drive motor constant at the same speed, in particular the positioning speed, for a first holding period in the positioning mode. The at least one knife carrier moves continuously back and forth at a speed reduced relative to the working mode within the first holding period. By releasing the throttle lever and/or the other operating element, if present, the drive motor and consequently the knife carrier can be stopped in the current position.

Alternatively or in addition, in one example, the control apparatus is designed to alternately control the speed of the drive motor in the positioning mode, in particular to increase and decrease it. In particular, the speed of the drive motor is cyclically set to zero revolutions per minute. The speed can, for example, have a sawtooth-shaped curve. This means that the speed can rise continuously to the positioning speed and then drop abruptly to zero once the positioning speed has been reached. Once the positioning speed has been reached, the speed can also be held for a holding period before dropping to zero. The dropping from the positioning speed to zero can also be gradual. It can also be provided that the speed has a sinusoidal curve. The sinusoidal curve can run at half the positioning speed. It can also be provided that the speed has a sinusoidal curve around zero speed, i.e., the direction of rotation of the drive motor changes during the positioning mode. The cycle of speed increase and speed decrease repeats as long as the throttle lever is actuated. In one example, the control apparatus is designed to keep the speed constant at zero for a second holding period after it has dropped to zero before the speed increases again. The drive motor therefore remains stationary cyclically for a second holding period during the positioning mode. The second holding period allows the operator to select the position of the knife carrier reached when the drive motor stops by simply releasing the throttle lever. The second holding period is in particular between 0.5 and 2 seconds. Due to the standstill of the at least one driven knife carrier, the operator can see the relative alignment of the knife carriers even better and can assess even more easily whether this alignment of the knife carriers is suitable for maintenance and should be maintained.

In one example, the garden tool is designed such that the at least one driven knife carrier stops in a different relative position to the second knife carrier each time the drive motor stops. This offers the operator a choice of different alignments of the knife carriers relative to each other. To achieve this, the number of revolutions of the drive motor performed within a cycle is matched to the number of revolutions of the drive motor required for a double stroke. The fact that the drive motor does not rotate exactly as many times or a multiple thereof between successive stops, i.e. within a cycle, as would be required for exactly one back-and-forth movement of the knife carrier, prevents the knife carrier from coming to a standstill in the same position each time the drive motor stops. Since the number of revolutions that would require exactly one back-and-forth movement of the knife carrier is not a multiple of the number of revolutions between successive stops, i.e., within one cycle, the exact position of the knife carrier does not automatically repeat itself after a few cycles that would correspond to the multiple. This ensures that various different positions of the knife carrier are assigned to the successive stops of the drive motor, from which the operator can select a position.

### BRIEF DESCRIPTION OF THE DRAWINGS

Further features of the disclosure are apparent from the description and the drawing, in which examples of the disclosure described in detail below are reproduced. Here:

FIG. 1 shows a schematic representation of the hand-held garden tool according to the disclosure, here in an example as a hedge trimmer,

FIG. 2 shows a detailed view in the area of the throttle lever of the hand-held garden tool of FIG. 1 according to detail Y in FIG. 1,

FIG. 3 shows a first example time course of the degree of actuation of the throttle lever of the hand-held garden tool without detectable intermediate states of the throttle lever and the resulting activation or deactivation of the positioning mode, working mode, and the time course of the speed of the drive motor,

FIG. 4 shows a diagram according to FIG. 3, wherein the control apparatus alternately controls the speed in the positioning mode,

FIG. 5 shows a second example time course of the degree of actuation of the throttle lever of the hand-held garden tool with detectable intermediate states of the throttle lever and the resulting activation or deactivation of the positioning mode, the working mode and the time course of the speed of the drive motor,

FIG. 6 shows a diagram according to FIG. 5, wherein the control apparatus alternately controls the speed in the positioning mode,

FIG. 7 shows a detailed view of the cutting device of the hand-held garden tool of FIG. 1 according to detail Z in FIG. 1.

### DETAILED DESCRIPTION

FIG. 1 shows a hand-held garden tool 1 in an example as a hedge trimmer. The garden tool 1 has a housing 2. A first handle 3 and a second handle 4 are arranged on the housing 2. A throttle lever 5 is arranged on the first handle 3 for indirect control of the drive motor 10 via a control apparatus 9. Another operating element 15 can be arranged on the second handle 4, which together with the throttle lever 5 forms a two-hand control. The drive motor 10 is supplied with power via a battery pack 8. The battery pack 8 can be arranged in or on the housing 2 and can be replaced without tools. The drive motor 10 rotates about a motor axis 80 at a speed n. In the example, the drive motor 10 drives a reduction gear 11, which is designed as a planetary gear. The reduction gear 11 drives a conversion gear. In the example, the conversion gear is designed as an eccentric gear in which an eccentric shaft 20 is driven by the reduction gear 11. A first eccentric 21 with a first eccentric axis 81 and a second eccentric 22 with a second eccentric axis 82 are arranged on the eccentric shaft 20, via which a first knife carrier 6 and a second knife carrier 7 are reciprocatingly driven in a known manner in opposite directions relative to each other. The knife carriers 6, 7 move in a longitudinal direction 85 opposite to each other. Alternatively, it can also be provided that the knife carriers 6, 7 are driven via connecting rods which are mounted on the eccentrics 21, 22. It can also be provided that only one of the knife carriers 6, 7 is driven.

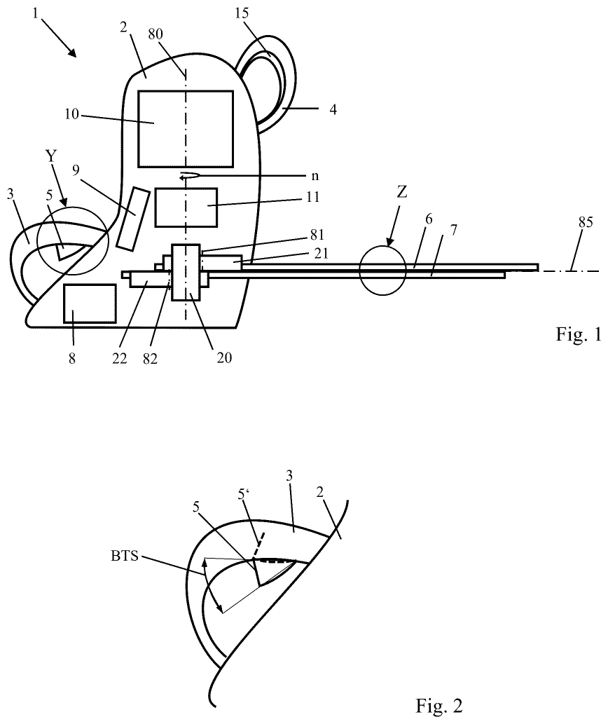

The first handle 3 is shown in FIG. 2 with two different positions of the throttle lever 5, 5′. In the first position, the throttle lever 5 is shown in an unactuated position, i.e., with a degree of actuation of 0%. In the second position, the throttle lever 5′ is shown in a fully actuated position, i.e., with a degree of actuation of 100%, indicated by a dashed line. Between the unactuated position and the fully actuated position of the throttle lever 5, there is a range of actuation BTS of the throttle lever 5.

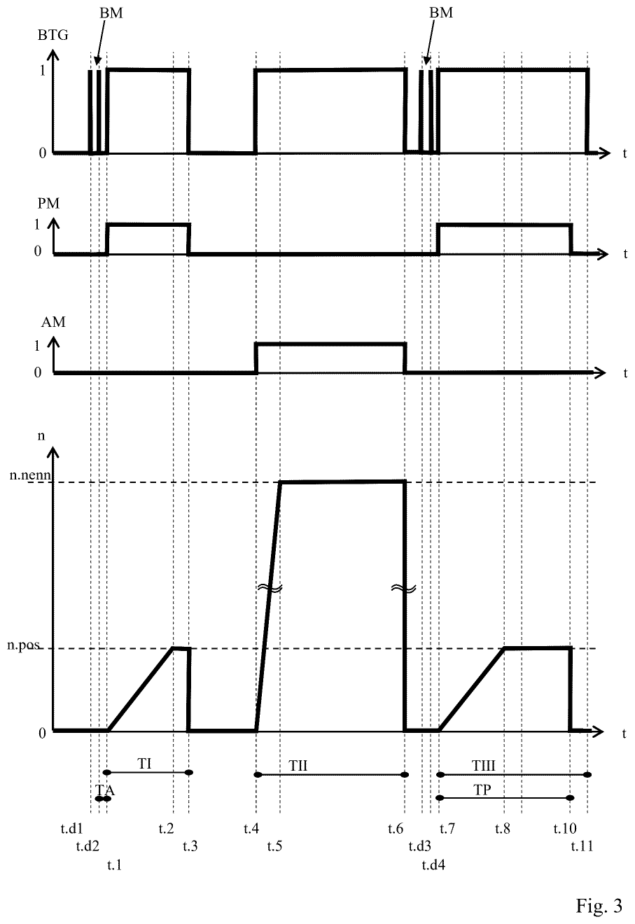

FIG. 3 shows a first example curve of the degree of actuation BTG of the throttle lever 5 of the hand-held garden tool 1 without detectable intermediate states of the throttle lever 5 and the resulting activation or deactivation of positioning mode PM, working mode AM, and the speed n of the drive motor 10 over time t. The state “0” in the PM(t) or AM(t) diagram designates a deactivated state. The state “1” in the PM(t) or AM(t) diagram designates an activated state. Within a first time interval TI from times t.1 to t.3, within a second time interval TII from times t4 to t6, and within a third time interval TIII from times t7 to t11, the throttle lever 5 is actuated continuously, i.e., the degree of actuation BTG is continuously 100%. Both the first time interval TI and the third time interval TIII are preceded by an actuation pattern BM of the throttle 5. In the example, the actuation pattern BM is executed in the form of a double click at times t.d1, t.d2, and t.d3, t.d4. By actuating the throttle lever 5 again at times t.1 and t.7, the positioning mode PM is activated and maintained as long as the throttle lever 5 is actuated. A time element TA between the actuation pattern BM and the repeated actuation of the throttle lever 5 is, in particular, no more than one second. If the throttle lever 5 is actuated after the actuation pattern BM has been executed and only after the time element TA has elapsed, the working mode AM is activated. Successive actuations of the throttle lever 5 during the actuation pattern BM are, in particular, at most by the time element TA, in particular less than one second, and in particular at most 0.5 seconds apart. After detecting the actuation pattern BM, the speed n of the drive motor 10 is limited by the control apparatus 9 to a positioning speed n.pos. The positioning speed n.pos is at most 2% of the rated speed n.nenn of the drive motor 10. For better clarity, the speed curve n(t) is shown in the working mode AM in a compressed manner. In the positioning mode PM, the control apparatus 9 reduces positive acceleration of the drive motor 10 as appropriate. This can be seen from the flatter rise of the speed curve in the time intervals t.1 to t.2 compared to the time intervals t.4 to t.5. After the positioning speed n.pos is reached, it is held constant for a holding period, here from t.2 to t.3 or from t.8 to t.10.

As shown in the example at time t.10, it can be provided that the positioning mode PM is terminated by the control apparatus 9 despite the throttle lever 5 being actuated. This can be triggered by the drive motor 10 exceeding a permissible temperature limit, or by the positioning mode PM being active for a positioning time TP that exceeds a maximum positioning time stored in the control apparatus 9, or by the number of revolutions of the drive motor 10 exceeding a specified limit value. The area under the speed curve corresponds to the number x of revolutions of the drive motor 10 in the period under consideration. At time t.3, none of these individual termination criteria were fulfilled and positioning mode PM was terminated by releasing the throttle lever 5. By releasing the throttle lever 5 at time t.3, the operator selected the alignment of the knife carriers 6 relative to each other that was present at that time.

In the example, for the sake of simplicity, it is only described that the throttle lever 5 is released. If a two-hand control is provided, it can also be provided that the operator releases the other operating element 15 of the two-hand control instead of the throttle lever 5 in order to select the position of the at least one knife carrier 6, 7.

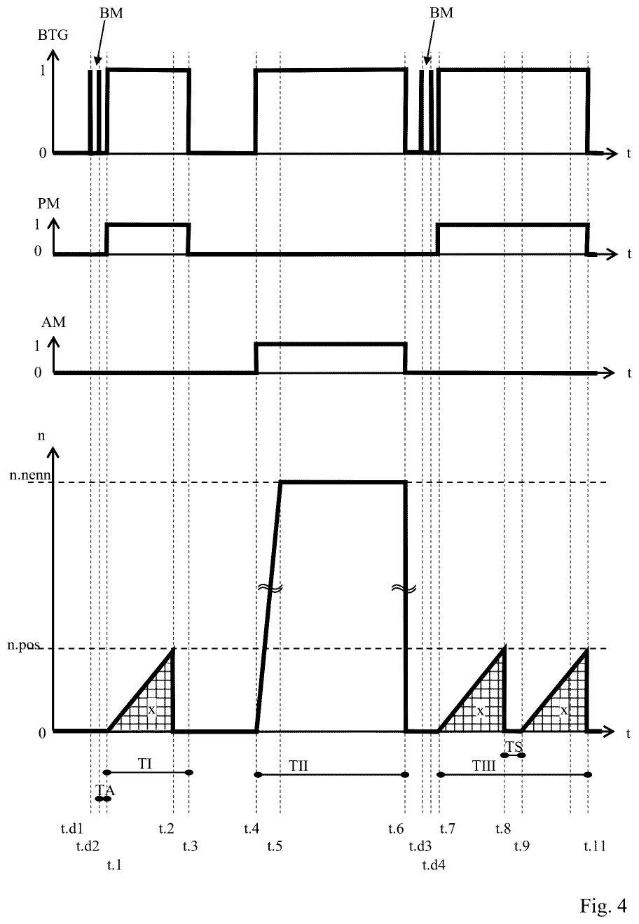

The diagrams shown in FIG. 4 essentially correspond to those in FIG. 3, which is why only the differences are described below and reference is otherwise made to the previous description of FIG. 3. In contrast to FIG. 3, FIG. 4 shows a speed curve n(t) controlled alternately by the control apparatus 9 in the positioning mode PM. Here, the speed n takes on values between zero and the positioning speed n.pos. This means that the control apparatus 9 controls the drive motor 10 in such a way that the drive motor 10 remains stationary in the positioning mode PM despite the throttle lever 5 being actuated. The drive motor 10 can be temporarily switched off at time t.2 or t.8, i.e. immediately after reaching the positioning speed n.pos, as shown. Alternatively, it can also be provided that the speed n of the drive motor 10 is kept constant at the positioning speed n.pos for a defined time before the control apparatus 9 temporarily switches off the drive motor 10.

The alternating speed curve is coordinated in particular such that the drive motor 10 has completed a defined number of revolutions x between the start of a cycle, here at time t.1 or t.7 or t.9, and the end of the cycle, here at time t.2 or t.8 or t.11. The area under the speed curve indicates the number of revolutions x of the drive motor 10 in the time interval. The positioning speed n.pos and/or the duration of the cycle are coordinated in particular such that the number x of revolutions in the cycle does not correspond to a number y of revolutions, or a multiple thereof, which the drive motor 10 requires for exactly one reciprocating movement of the knife carriers 6, 7. This prevents the knives of the knife carriers 6, 7 from coming to a standstill in the same relative alignment with each other each time the drive motor 10 stops. The number x can, for example, be set to
x=(y/p)+y*f, wherein 3≤p≤10 and f=[0, 1, 2, 3, 4, 5]

The parameter p is at most ten so that the knife carriers 6, 7 and thus the knives move a minimum distance in each cycle. The parameter p is at least three so that the operator is offered several alignments of the knife carriers 6, 7 for resharpening. The number x of revolutions of the drive motor 10 in the cycle can alternatively or additionally be adjusted so that the number y is not a multiple of the number x. This means that the parameter p can be a rational number. In this way, the operator is offered more alignments of the knife carriers 6, 7 relative to each other.

In FIG. 4, the throttle lever 5 is released at time t.3. Since the time interval between t.3 and t.2 was shorter than a second holding period TS stored in the control apparatus 9, the drive motor 10 was not restarted in the meantime. When the throttle lever 5 was released at time t.3, the positioning mode PM was ended and the alignment of the knife carriers 6 already achieved at time t.2 was maintained. By releasing the throttle lever 5 at time t.3, the alignment of the knife carriers 6 was selected by the operator. In contrast, the throttle lever 5 was not released during the time between t.8 and t.9, and the alignment achieved at time t.8 was not selected.

The positioning mode PM, which lasts from time t.7 to t.11, has a complete cycle from times t.7 to t.8. The speed n is held at zero for a second holding period TS, which lasts from times t.8 to t.9, before a new cycle begins at time t.9. By releasing the throttle lever 5 at time t.11, the positioning mode PM is terminated before the positioning speed n.pos is reached. In contrast to the speed curve in FIG. 3, the positioning mode PM in FIG. 4 is not terminated prematurely by reaching a limit value stored in the control apparatus 9. This is to illustrate that, for example, the integral of the speed curve, i.e., the number x of revolutions of the drive motor 10 during the period, can represent a switch-off criterion that was reached in the speed curve according to FIG. 3 in the period t.7 to t.10 and has not yet been reached in the speed curve according to FIG. 4 in the period t.7 to t.11.

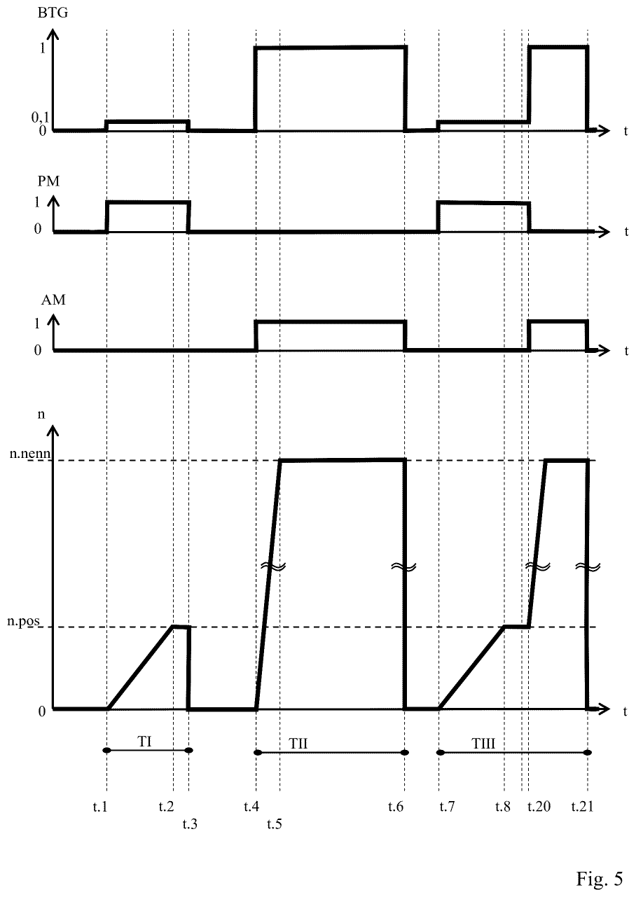

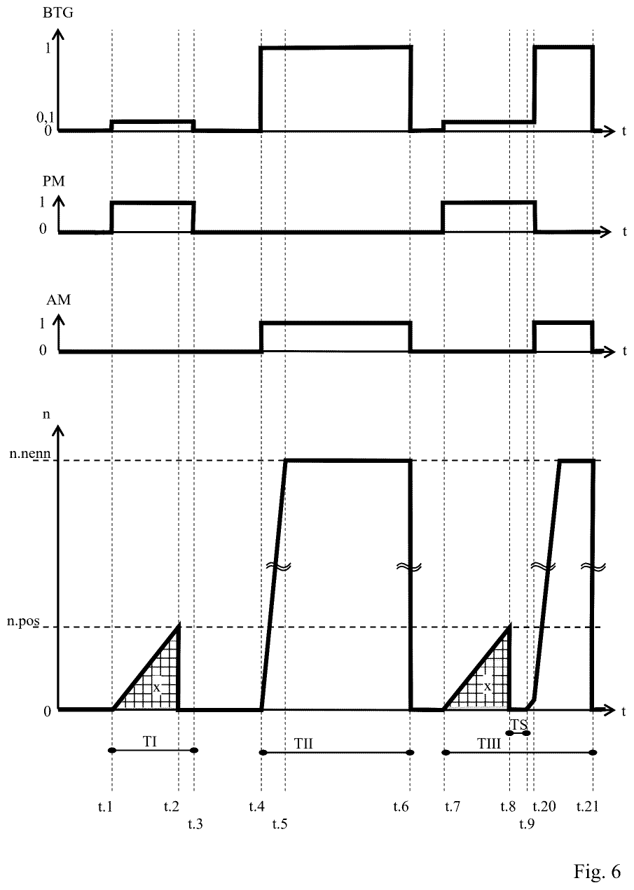

FIGS. 5 and 6 show diagrams that largely correspond to those in FIGS. 3 and 4, respectively, which is why only the differences are described below and reference is otherwise made to the previous description of FIGS. 3 and 4. The example corresponding to FIGS. 5 and 6 differs from the example corresponding to FIGS. 3 and 4 in that the throttle lever 5 has intermediate states that can be detected by the control apparatus 9. In this way, the positioning mode PM can now be activated in accordance with FIGS. 5 and 6 by actuating the throttle lever 5 with a degree of actuation BTG of no more than 10%. An actuation pattern BM as described in FIGS. 3 and 3 can thus be omitted. Actuating the throttle lever 5 at time t.1 or t.7 with a degree of actuation BTG of 10% activates the positioning mode PM. Since the degree of actuation BTG can be detected by the control apparatus 9, it is possible to switch directly from the positioning mode PM to the working mode AM by actuating the throttle lever 5 more strongly, in particular by increasing the range of actuation BTS by at least 10%, as shown, for example, at time t.20. The third time interval TIII, in which the throttle lever 5 is continuously actuated, also begins at time t.7 and ends at time t.21. In the third time interval, the positioning mode switches directly to the working mode. In FIG. 5, the speed n increases directly from the positioning speed n.pos already reached. In FIG. 6, a new alternating speed cycle started at time t.9. At time t.20, the drive motor 10 was still accelerating to the positioning speed n.pos and was caused by the control apparatus 9 to accelerate more strongly due to the activation of the working mode AM. At time t.21, the working mode AM was deactivated by releasing the throttle lever 5. The increase in speed n is a measure of the acceleration. In all FIGS. 3 to 6, it is provided that the drive motor 10 accelerates more slowly in the positioning mode PM than in the working mode AM.

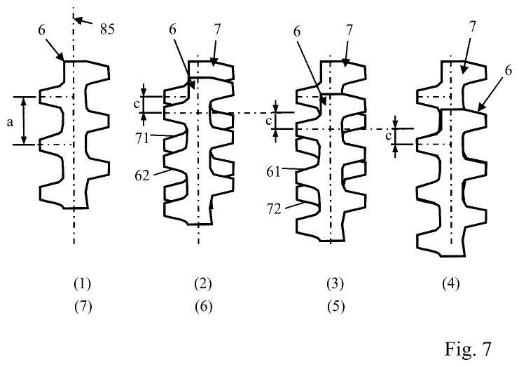

FIG. 7 shows a section of the garden tool 1 of FIG. 1 in the area of the first knife carrier 6 and the second knife carrier 7 in a schematic manner. The knife carriers 6, 7 are shown here in example alignments (1) to (7) relative to each other, which, in the case of alternating control of the speed curve by the control apparatus 9, have been set one after the other at zero speed in successive cycles. As can be seen, the number x of revolutions of the drive motor 10 per cycle is adjusted so that this corresponds to only approx. ⅙ of the number y of revolutions per double stroke. The knife carriers 6, 7 therefore only perform a displacement c of approximately ⅓ of a stroke or approximately ⅙ of a double stroke in the positioning mode PM with alternating control from one stop to the next stop. The length of a stroke corresponds to the distance a between adjacent knives. The distance a between adjacent knives is twice the eccentricity of the eccentrics 21, 22 when the knife carriers 6, 7 are driven in opposite directions, and the single eccentricity when only one knife carrier 6, 7 is driven. Due to the fact that the knife carriers 6, 7 and thus the knives are shifted by a predefined offset c from one cycle to the next, the operator can see when which alignment is automatically achieved when the positioning mode PM is activated. This allows the operator to release the throttle lever 5 when the knife carriers stop in the second alignment and sharpen the rear edges 62 of the knives of the first knife carrier 6 and the front edges 71 of the knives of the second knife carrier 6. When the positioning mode is activated again, for example by actuating the throttle lever in the actuation pattern BM or with a degree of actuation of max. 10%, the knife carriers move again by an offset c and, when they stop automatically, they reach the third alignment. This allows the operator to resharpen the remaining front edges 61 of the knives of the first knife carrier 6 and the rear edges 72 of the knives of the second knife carrier 6. FIG. 7 shows an example in which the parameter p is selected as an integer in order to return to the initial alignment of the knife carriers 6, 7 relative to each other after p cycles have been completed. This makes it particularly easy for the operator to predict when the knife carriers 6, 7 will assume a certain alignment relative to each other. However, this also limits the number of alignments. Therefore, it can also be provided that p is not selected as an integer in order to increase the variety of alignments that can be achieved.

Due to the slow movement of the knife carriers 6, 7 in the positioning mode PM, the operator can achieve any desired alignment of the knife carriers 6, 7 relative to each other with just a few attempts by releasing the throttle lever 5. If an alternating speed curve is provided, the knife carriers also stop automatically in incrementally shifted alignments and the operator only has to release the throttle lever within the second holding period TP when the alignment is satisfactory. The various examples described for the operator-controlled positioning of at least one driven knife carrier 6 can also be used for garden tools 1 in which the control apparatus 9 has no information about the position of a rotor of the drive motor 10.

1. A hand-held garden tool for operator-controlled positioning of a knife carrier, in particular a hedge trimmer or a rotary trimmer, comprising at least one reciprocatingly driven knife carrier, a handle with a throttle lever, a drive motor for driving the knife carrier and a control apparatus for controlling a speed of the drive motor, characterized in that the control apparatus is designed to control the speed of the drive motor as a function of a selectable positioning mode of the garden tool, wherein the speed of the drive motor in the positioning mode is limited to a positioning speed such that the knife carrier is moved back and forth at most twice per second, in particular at most once per second, in the positioning mode.

2. The garden tool according to claim 1, characterized in that the control apparatus is designed to activate the positioning mode by actuating the throttle lever, in particular when the control apparatus detects at least one
i) the throttle lever is actuated to a degree of actuation that is less than or equal to a limit degree of actuation,
ii) the throttle lever is actuated in an actuation pattern stored in the control apparatus and the throttle lever is actuated within a specified time period after the actuation pattern is performed, or
iii) an operating element of the garden tool other than the throttle lever is actuated and the throttle lever is then actuated within a specified time period.

3. The hand-held garden tool according to claim 1, characterized in that the control apparatus is designed to deactivate the positioning mode if the control apparatus detects at least one of
i) the throttle lever has been released,
ii) a degree of actuation of the throttle lever has exceeded a limit degree of actuation of the throttle lever,
iii) a degree of actuation of the throttle lever has increased by at least one limit range of actuation of the throttle lever, or
iv) a positioning time period which has elapsed since activation of the current positioning mode is greater than a maximum positioning time period stored in the control apparatus.

4. The hand-held garden tool-(according to the-immedia claim 3, characterized in that the garden tool has a working mode and that the garden tool is designed such that it switches directly from the positioning mode to the working mode when the control apparatus detects that the degree of actuation of the throttle lever has increased by at least the limit range of actuation.

5. The hand-held garden tool according to claim 1, characterized in that the control apparatus is designed to control the speed of the drive motor in the positioning mode in such a way that the speed lies within a first speed range, wherein the first speed range extends from zero revolutions per minute to a positioning speed, wherein the positioning speed corresponds to at most 2% of a rated speed of the drive motor.

6. The hand-held garden tool according to claim 5, characterized in that the control apparatus is designed to maintain the speed of the drive motor at a constant speed, in particular the positioning speed, for a first holding period in the positioning mode.

7. The hand-held garden tool according to claim 5, characterized in that the control apparatus is designed to alternately control the speed of the drive motor within the first speed range in the positioning mode.

8. The hand-held garden tool according to claim 7, characterized in that the control apparatus is designed to set the speed of the drive motor cyclically to zero revolutions per minute in the positioning mode.

9. The hand-held garden tool according to claim 7, characterized in that the control apparatus is designed to keep the speed of the drive motor constant at zero revolutions per minute for a second holding period in the positioning mode.

10. The hand-held garden tool according to claim 7, characterized in that the garden tool is designed such that the drive motor has rotated by a number of revolutions between a first stop and an immediately following stop and the knife carrier requires a number of revolutions of the drive motor for a reciprocating movement, and the number of revolutions between the stops is not a single or multiple of the number of revolutions required for a reciprocating movement of revolutions of the drive motor for a reciprocating movement, and wherein the number of revolutions between the stops is not a single or multiple of the number of the required revolutions and/or wherein the number of the required revolutions is not a multiple of the number of revolutions between the stops.
